(19) United States
(12) Patent Application Publication
(10) Pub. No.: US 2013/0011051 A1
(43) Pub. Date: Jan. 10, 2013

(54) CODED APERTURE IMAGING

(75) Inventors: DAVID BOTTISTI, WINDERMERE, FL (US); ROBERT R. MUISE, OVIEDO, FL (US)

(73) Assignee: LOCKHEED MARTIN CORPORATION, Bethesda, MD (US)

(21) Appl. No.: 13/544,741

(22) Filed: Jul. 9, 2012

Related U.S. Application Data
(60) Provisional application No. 61/505,413, filed on Jul. 7, 2011.

(51) Int. Cl. G06K 9/36; G06K 9/62

(52) U.S. Cl. 382/159; 382/232

(57) ABSTRACT

A method of imaging encodes light from a scene by adding projective codes expressed as a product of a known projective code matrix with a known reconstruction matrix representing an image reconstruction operation. The encoded light is detected at a photodetector. The measurements are processed by compressive sensing including projective sub-sampling to represent the measurements as a linear system. The linear system is expressed as a plurality of undetermined linear equations including a product of the known reconstruction matrix and an unknown sparse vector. The sparse vector is approximated to provide solutions to the undetermined linear equations. At least one of a reconstructed image and an exploited image is generated from the measurements using solutions to the undetermined linear equations, wherein a product of the known reconstruction matrix with the solutions to underdetermined linear equations provides an image representation of the scene of interest having N pixels, where N>k.

### CROSS REFERENCE TO RELATED APPLICATIONS

This application claims the benefit of Provisional Application Ser. No. 61/505,413 entitled “CODED APERTURE IMAGING” filed Jul. 7, 2011, which is herein incorpbrated by reference in its entirety.

### FIELD

Disclosed embodiments relate to coded aperture imaging.

### BACKGROUND

Detecting targets of interest within wide area imagery is a highly computationally intense procedure. In addition, sensing such imagery generally involves very large area sensors. The combination of these factors makes this important step in wide-area surveillance expensive.

Conventional target detection algorithms operate on full-resolution imagery. This is achieved by one of two processes. For very wide area surveillance, gathering imagery with a single camera is generally prohibitive. Operating target detection algorithms using images from multiple cameras adds cost and complexity as it requires extra computations and additional sensor alignment algorithms.

### SUMMARY

Disclosed embodiments include coded aperture imaging where the light field from a scene of interest is measured after adding specialized projective codes which allow for significantly fewer measurements collected by the detector array. Such imaging combines compressive sensing and automatic target recognition (ATR) to compressively sense a feature map. Compressive sensing can comprise projective sub-sampling imagery so that the measurements can be represented using a linear system. The linear system can then be represented as the product of a known reconstruction matrix and an unknown, sparse vector. Using sparse solvers, the sparse vector can be approximated, and in turn the original (target) image is reconstructed. Moreover, disclosed specialized measurement codes allow for reconstruction of an exploited image directly, without the intermediate step of forming the actual image.

The known reconstruction matrix can comprises an identity matrix so that the generating provides a reconstructed image. In another embodiment, the reconstruction matrix comprises a known exploitation matrix, the projective codes comprise exploitation-projective codes, and the generating provides an exploited image.

### BRIEF DESCRIPTION OF THE DRAWINGS

FIG. 1 is block diagram depiction of an example coded aperture imaging system for imaging within a scene of interest, according to an example embodiment.

FIG. 2 is a data flow diagram depicting an example of disclosed filter-bank training, according to an example embodiment.

FIG. 3a-d are depictions of example 4 x 4 “masks”, according to an example embodiment.

FIG. 4 is a plot of the mean squared error (MSE) of a disclosed algorithm vs. known bilinear reconstruction.

### DETAILED DESCRIPTION

Disclosed embodiments are described with reference to the attached figures, wherein like reference numerals, are used throughout the figures to designate similar or equivalent elements. The figures are not drawn to scale and they are provided merely to illustrate aspects disclosed herein. Several disclosed aspects are described below with reference to example applications for illustration. It should be understood that numerous specific details, relationships, and methods are set forth to provide a full understanding of the embodiments disclosed herein. One having ordinary skill in the relevant art, however, will readily recognize that the disclosed embodiments can be practiced without one or more of the specific details or with other methods. In other instances, well-known structures or operations are not shown in detail to avoid obscuring aspects disclosed herein. Disclosed embodiments are not limited by the illustrated ordering of acts or events, as some acts may occur in different orders and/or concurrently with other acts or events. Furthermore, not all illustrated acts or events are required to implement a methodology in accordance with this Disclosure.

Notwithstanding that the numerical ranges and parameters setting forth the broad scope of this Disclosure are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 5.

One disclosed embodiment is a method of image exploitation. Encoded light is generated from light emanating from a scene of interest by applying projective codes, such as exploitation-projective codes, before detection at the photodetector. In one embodiment exploitation-projective codes are expressed as a product of a known projective code matrix with a known exploitation matrix representing an image exploitation operation/process. Use of exploitation-projective codes can enable generation of both a reconstructed image and an exploited image, while use of projective codes alone can generate only the reconstructed image.

The exploitation-projective codes can be designed mission specific to accommodate different target types for detection and/or target recognition. The exploitation codes, being that they are represented as the product of a matrix with the scene of interest, are by nature, linear codes. Therefore, any linear filtering process can be designed into the exploitation codes. For example, target detection linear filters trained from previous data can be designed to respond to targets present in imagery, and thus, be similarly encoded into exploitation code matrices. The QCF discussion below is another example of target detection filtering algorithms being incorporated into the sensing code matrices.

The encoded light is detected at a photodetector array to generate a plurality (k) of measurements. When the exploitation operation is intrinsically linear, the mathematical adjoint of the exploitation process can be applied to the projective encoding, thereby producing a composite encoding scheme which when processed through the rest of a disclosed algorithm, can reconstruct the exploited scene, rather than reconstruct the image of the scene.

A Quadratic Correlation Filter (QCF) is an example of a filter that can implement a reconstruction process or exploitation process. A QCF is represented mathematically as a group of linear filters which will “detect” targets of interest in the image. Since the QCF is based upon linear processing, each filter in the filter bank can be represented as a convolution matrix which can be applied to the designed encoding matrix, rather than to the image. This results in measurements collected by the photodetector which will reconstruct the processed scene rather than the image (when the rest of the algorithm sequence is left unchanged).

The plurality (k) of measurements provided by the photodetector are signal processed (e.g., by a digital signal processor) by compressive sensing including projective sub-sampling to represent the plurality (k) of measurements as a linear system, where the linear system is expressed as a plurality of undetermined linear equations including a product of a known reconstruction matrix and an unknown sparse vector. The sparse vector is approximated to provide solutions to the undetermined linear equations. At least one of a reconstructed image and an exploited image is then generated from the plurality (k) of measurements using the solutions to the undetermined linear equations. As used herein “an exploited image” is the result of a known linear operator applied to a N-pixel image, or is the result of convolving an image with a known exploitation kernel. The product of the known reconstruction matrix with the solutions to the underdetermined linear equation provides an image representation of the scene of interest having N pixels, wherein N>k.

Disclosed methods can provide image reconstruction from the scene of interest by having the known exploitation matrix become an identity matrix. In this embodiment the generating step further provides a reconstructed image.

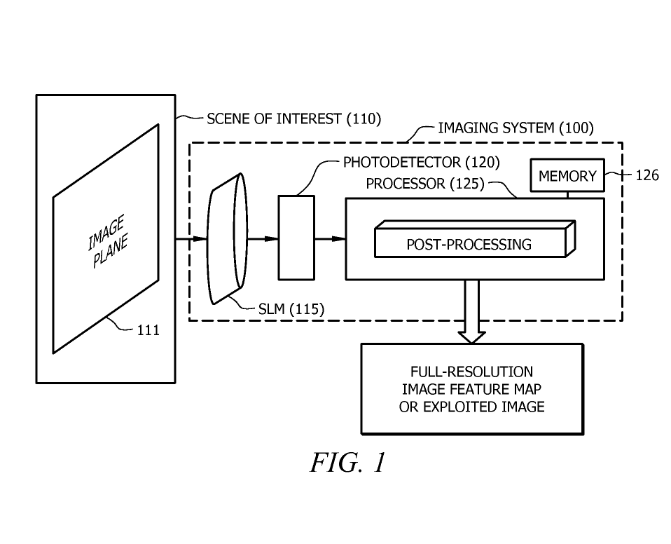

FIG. 1 is block diagram of an example coded aperture imaging system 100 for imaging an image plane 111 within a scene of interest 110, according to an example embodiment. System 100 includes a spatial light modulator (SLM) 115 that is optically coupled to a photodetector array (photodetector) 120 that generates a plurality (k) of measurements.

Photodetector 120 thus measures the light field from the scene of interest 110 after the addition of specialized projective codes, such as exploitation-projective codes when generating an exploited image, that are applied by SLM 115 which allow for high resolution imagery with significantly fewer measurements from the photodetector 120 as compared to known imaging systems. There is also no need to sacrifice resolution or reduce the field of view (FOV) of the image generated. A processor 125 receives the plurality of measurements from photodetector 120 that runs a disclosed image exploitation and/or optional image reconstruction algorithm stored in memory 126.

In the case of exploitation-projective codes added by SLM 115, the exploitation-projective codes are expressed as a product of a known projective code matrix with a known exploitation matrix representing an image exploitation operation. The exploitation-projective codes can be basically the same as the algorithm specific sensing codes used by processor 125, along with codes for image formation. The terms “exploitation-projective codes” and “algorithm specific sensing codes” refer to the same concept, and are interchangeable terms as used herein SLM 115 as used herein is a general term for a transmissive device which applies projective codes to light coming from the scene of interest 110 and transmits the encoded light to a photodetector 120. SLM 115 can comprise a digital micro-mirror array (DMA), a liquid crystal device, or comprise other transmissive modulating devices, such as an eyelid array.

Photodetector 120 can comprise any standard photon sensing device used for imaging. For example a CCD array, a photodiode array, a CMOS detector array, or a detection film. Photodetector 120 can include cryogenic cooling.

Processor 125 can comprise a digital signal processor (DSP) or a microcomputer. As noted above, processor 125 runs a disclosed image exploitation and/or image reconstruction algorithm. Disclosed image reconstruction algorithms are generally based on the mathematical theory of compressive sensing. For example, if k encoded measurements of the scene of interest 110 are gathered, but it is desired to reconstruct an image with N pixels, there is a substantial throughput benefit when k<<N. Each encoded measurement (k) provided by photodetector 120 can be viewed as a linear equation representing a plurality of encoded pixels. This means there are fewer equations (measurements) than unknowns (N pixels). Thus, there is an underdetermined system of equations that as disclosed herein is solved by sparse vector approximation to provide the pixel data (N pixels).

A pattern recognition application in image processing can be designed and implemented as a convolution operation, or as a filtering operation (a linear process). The “training” of a filter bank implementing an example filtering algorithm (by including for example a QCF) can design a filter kernel (or set of kernels for the QCF) which will yield a high y value response (Y is the visual image) when presented with a target of interest and a suppressed (lower) y value response when presented with a non-target. The QCF designs a set of linear filters which thus function to separate targets from non-targets (e.g., based upon a prior reference dataset provided). Since these designed filter kernels are linear processes and the encoding can be designed as a linear projection, these two linear processing steps can be combined into one linear encoding step to do both the original problem of encoding the image pixels for later reconstruction and also the target detection filtering simultaneously.

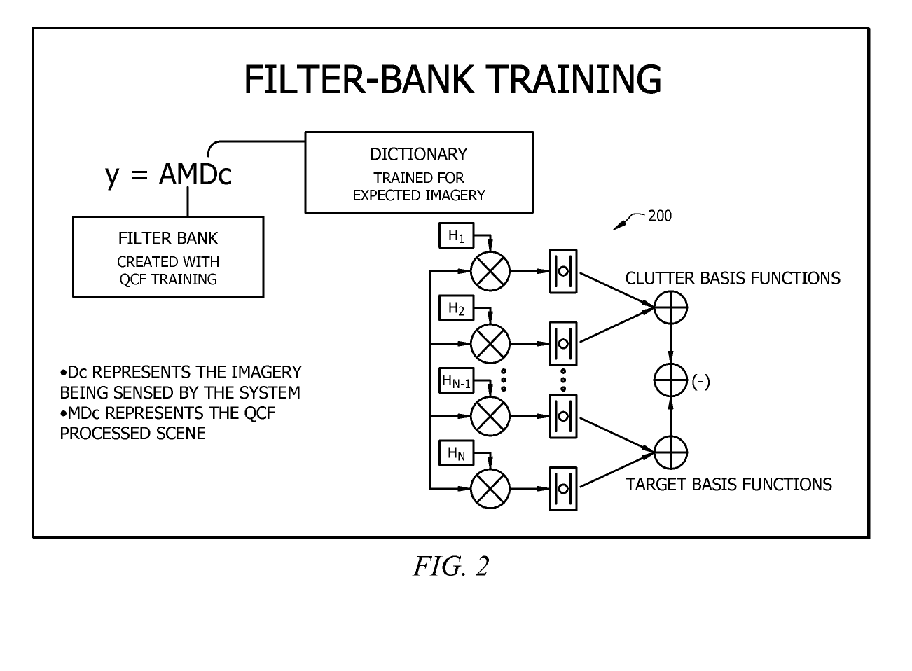

FIG. 2 is a data flow diagram 200 depicting an example of disclosed filter-bank training, according to an example embodiment. An equation in FIG. 2 for the system response is shown as y=AMDc, where y represents the system response (typically a visible image), A represents the projective code matrix, M represents the filter bank created with QCF training, D represents the learned dictionary for the expected imagery, c represents sparse coefficients, so that Dc represents the imagery being sensed by the system, and MDc represents the filter band (e.g., QCF) processed scene. Image reconstruction is created by solving y=ADc for c, and then computing Dc. Feature map reconstruction is created by solving y=AMDc for c, and then computing: MDc.

H₁ through Hₙ correspond to a set of linear filters (H) which, as an aggregate H₁ through Hₙ, act as a single quadratic correlation filter (QCF). Each filter is applied to the data, the results then go through a magnitude-squared operation to calculate energy. As shown, the first several filters in the operation, after QCF training, represent features which are typical of clutter (or uninteresting image information), while the later filters are designed to represent features typical of the targets of interest for detection. Thus, subtracting the energy of each set of filters will result in a statistic which is large positive in areas where targets are present and large negative in “clutter” areas where there are no targets present. This aspect is discussed in more detail beginning under image exploitation in the examples section.

By combining the exploitation and compressive sensing algorithms, disclosed embodiments construct feature maps using far fewer samples than is traditionally required for this process. This results in the ability to use much smaller, less expensive sensors. In addition, disclosed algorithms do not generally involve any additional computational time beyond that involved in current state-of-the-art compressive sensing reconstruction algorithms.

### EXAMPLES

Disclosed embodiments are further illustrated by the following specific Examples, which should not be construed as limiting the scope or content of this Disclosure in any way.

Some mathematical background is provided before disclosing details of the specific algorithms developed. It has long been known that given a basis set, such as the discrete cosine transformation (DCT), a compressible image can be represented as a collection of only those coefficients with the most energy (highest absolute value). These coefficients can then be used to reconstruct an approximation of the original image without much loss of quality. In fact, the JPEG compression technique represents each 8×8 block of an image using only a few DCT coefficients.

Let i be a 64-element vector representing an 8×8 grayscale image I ordered lexographically. Furthermore, let A be an n×64, n<<64 encoding matrix used to subsample an input image. Then the goal of compressive sensing is to reconstruct i given an n-element vector y by solving

Ai=y

for i. As A has fewer rows than columns, this is an underdetermined system and therefore has infinitely many solutions.

Many algorithms exist for solving this underdetermined system when i is sparse. However, this is generally not the case for typical imagery. However, the system can be transformed into an equivalent sparse system in order to take advantage of these sparse solvers.

Let f(•) be a linear transformation to a known basis that can be represented by an orthogonal matrix φ. Then

c=f(x)=φx,

where c is the coefficient vector of y. Given that φ is orthogonal and it is known

### φ^{T}=φ⁻¹ so

c=φx,

φ⁻¹c=φx,

φ^{T}c=x.

The desired image i can be represented as i=φc. Then the earlier equation becomes

Ai=y,

Aφc=y,

ψ=y,

where w=Aφ.

Choosing a basis φ in such a way that c is sparse will allow us to use an algorithm such as Orthogonal Matching Pursuit (OMP) [see J. Tropp and A. Gilbert, “Signal recovery from random measurements via orthogonal matching pursuit”. IEEE Trans. on Information Theory, 53(12) pp. 4655-4666, December 2007] to find c. It is then a relatively simple matter to find i=φc.

2×2 Pixel Sampling

Using the mathematics described above, a first example approach will now be detailed to reconstruct an image I from a set of compressively sensed values. To do this, we can consider the image I as split into 8×8 regions and reconstruct each one independently. Once each patch has been reconstructed, the regions can be reassembled to form the final image.

Consider an 8×8 matrix consisting of only is and 0s where every non-overlapping 2×2 region contains one 1 and three 0s, randomly chosen. This matrix is referred to as a mask. This mask represents the pixels from the original image that are shone onto the sensor to create y. Each 2×2 region represents a single element of the sensor. Therefore this mask will allow reconstruction of an 8×8 region from only 16 pixels, resulting in 4× compression.

We now create the matrix A as a 16×64 matrix. For each small 2×2 block in the mask, we consider the 8×8 matrix A′ containing all 0s except where the corresponding pixel in the smaller block is on. This matrix A′ is then ordered lexigraphically, transposed, and set as a row of the resulting matrix A.

As described above, the sensed data can be modeled by the equation y=Ai. Once we have chosen a basis φ and computed ψ=φA, it's a relatively simple matter of applying the OMP algorithm to the equation ψc=y to find the coefficients c and ultimately i=φ^{T}c.

In order to refine the result even more, a total of 16 different possibilities are computed for the final image Iᵢ and they are averaged together in a process called “spatial coupling”. We obtain these Iᵢ by shifting the 8×8 reconstruction block to all of the various possibilities around the mask. Since each of the 8×8 blocks contain the same mask, this has the effect of moving rows from the top or left of the mask to the bottom and right respectively.

Choice of Basis

Up until now it has been assumed that the basis 4) was known a priori, and only hinted at the use of the DCT basis set. However, it turns out that the DCT basis set is generally a poor choice for a target sensing application since it will tend to create a great deal of high frequency noise within the output image. Instead a dictionary trained from real-world imagery can represent the image data more sparsely and is therefore a better choice for target sensing.

To train the dictionary, in this example we chose non-overlapping 8×8 chips from imagery collected from the same camera but of a different scene. A total of 409,600 chips were collected and then passed into the K-singular-value decomposition (SVD) algorithm to create the dictionary. Similar to the k-means algorithm, the K-SVD algorithm clusters the input chips and then creates basis vectors from them using SVD. Each input chip is then reassigned to a cluster based upon its similarity to the set of basis vectors. The process iterates until the set of basis vectors can reconstruct the input chips within a specified amount of error. We trained our dictionary to create 150 basis vectors, resulting in φ of size 64×150.

Results

Using the dictionary created from the procedure described above, we simulated the collection of data for a video sequence and used our algorithm to reconstruct an approximate solution. As a comparison, we performed bilinear interpolation on a regularly sampled image. The MSE for each type of reconstruction was measured and compared. The disclosed algorithm consistently performed better than the bilinear reconstruction, such as an MSE of 3.2 vs. an MSE of 5.5 for bilinear reconstruction.

4×4 Pixel Sampling with Temporal Coherence

While the performance of the previously described algorithm is very good, enhancements were added to it to reduce the number of samples and therefore increase its compression ratio. Note that as described above, each 8×8 block was constructed from 16 samples (one for every 2×2 region). To increase the compression ratio, we now gather one measurement for each 4×4 region, for a total of 4 pixels for every 8×8 block. This results in a compression ratio of 16×.

One downfall of this approach is that it results in each 8×8 image being reconstructed from only 4 samples. To increase the number of measurements, we sample data from 4 temporally consecutive 8×8 blocks. Not only does this increases our number of samples to 16 but also introduces temporal coherence, adding to the accuracy of the reconstructed image.

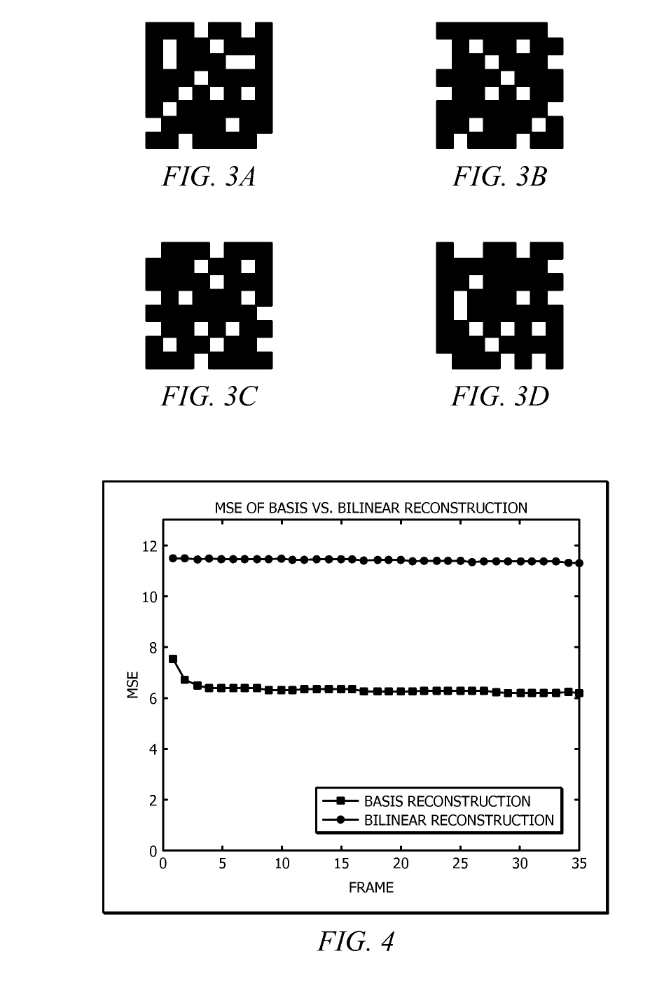

To sample the pixels, we create 4 masks as before with one pixel on for each non-overlapping 2×2 area. These masks are also constructed in such a way that every pixel is sampled exactly once within the sequence of 4 masks, as shown in FIGS. 3a-d. To sample the data, four values which are sampled in any given 4×4 region are summed together into a single measurement.

The A matrix is then constructed in a manner similar to that described above. For each 4×4 region in each mask, only the 4 pixels that are on are lit, and all others are off, including those in the other 3 masks. The four masks are then ordered lexigraphically, transposed, concatenated and added as a row of A. This continues top-to-bottom, left-to-right across all four masks to create the 16×256 matrix A.

Since our data is now gathered from 4 consecutive frames, the dictionary 4 needs to be redesigned. This new dictionary, which we call a “Dictionary Cube” is trained from image patches that are 8×8 and 4 frames deep, lexigraphically ordered and concatenated into a single vector. As before, we compute ψ=φA. Using the 16 element vector of sensed data y we use OMP to solve for c in ψc=y and finally calculate

i=φ^{T}c.

The vector i provides us with 256 elements, which are then ordered into four 8×8 blocks. After obtaining all of the 8×8 blocks to form a complete set of images I, we perform the spatial coupling refinement described previously, shifting instead by 4 pixels. The first of these four images are displayed, with the remaining three being stored to be later averaged with subsequent reconstructions in a process we refer to as “temporal coupling”.

Results

We generated the dictionary cube from 102,400 samples of size 8×8×4 to create a basis set with 1500 atoms. We tested this algorithm in a way similar to that described above. A comparison between a disclosed algorithm and the bilinear reconstruction created from an image regularly sampled from the original was performed. It was clearly seen that the disclosed algorithm reconstructs high-frequency areas much more accurately than the bilinear interpolation. FIG. 4 is a graph comparing the MSE of a disclosed algorithm to that of bilinear reconstruction. The reduction in MSE of the basis reconstruction that can be see within the first four frames is due to the buildup of images for temporal cohesion.

Computational Complexity Analysis

Since the computation of A, φ and ψ can be done offline, their complexity it not considered here. For each vector to be reconstructed, the complexity of the OMP algorithm is K²L+3KL+K³ where K is the number of coefficients in the vector c and L is the number of basis vectors in the dictionary. For K<<L, the complexity of the OMP algorithm becomes near linear in L. Assuming that an image I has N blocks of size 8×8, the complexity of reconstructing a single I is 0(NL).

For the 2×2 pixel sampling algorithm, 16 images were created in order to average a single frame. Thus the complexity of creating the final image is 16 0(NL). For the 4×4 reconstruction, only four images were created for a single frame (the averaging performed for temporal cohesion is negligible so it is ignored here). Therefore the complexity of this variant is 4 0(NL). Assuming the number of atoms in each dictionary is the same, we can see that both algorithms have equivalent big-O complexities, but the 4×4 variant is four times as fast due to the hidden coefficient.

Image Exploitation

Having established the ground work for a compressive sensing method, we now discuss a method whereby our reconstruction is not of the actual imagery, but instead an exploitation of the image. We can use a variation of the popular QCF two-class detection algorithm [see A. Mahalanobis, R. Muise, and S. R. Stanfill, “Quadratic Correlation Filter Design Methodology for Target Detection and Surveillance Applications”, Applied Optics, Vol. 43 Issue 27 Page 5198, September 2004] as the exploitative means, but the method described applies to any type of exploitation filter that is linear (or can be approximated as linearly).

Adjusting the Model

Recall the compressive sensing model described above

Ai=y,

Aφc=y.

The goal is to reconstruct not the original image i but rather the image processed by an exploitation filter such as Q. Thus, we want to reconstruct Qi=Qφk. The model then becomes:

AQi=y,

AQφc=y,

where AQ represents our new sampling matrix. We then let ψ′=AQφ and y′ be the new measurements, giving

ψ′c=y′.

Solving this equation using the dictionary-based reconstruction described above will yield c′, the coefficients of the exploited image. To reconstruct the exploited image, we simply compute:

Qi=Qφc′.

Since the matrices AQ, ψ′ and Qφ can all be computed a priori, there is no additional computation required to compute an exploited image verses a non-exploited one. This can save significant processing time in systems requiring real-time exploitation.

Results

To test the validity of this model, we trained a QCF filter Q from a set of space-time image chips of one moving vehicle. This filter was then used with the aforementioned model to simulate capturing of data with a sampling matrix AQ and reconstructed the Qi. exploited image.

Image exploitation results on a scene of video containing moving cars was obtained. A frame from the original uncompressed 512×512 video sequence was obtained, a sensed image frame at a size of 128×128, representing a 16× compression was obtained and a reconstructed exploited image frame was obtained. The peaks in the exploited image were found to correspond to the areas where moving cars are located within the original uncompressed scene.

High ratios of image pixels to sensor measurements obtainable with disclose embodiments (16× to 25× compression rate) provides automatic target detection (ATD)-processed imagery reconstructed directly without image formation, without any significant loss in image quality or FOV. Significant cost reduction is provided by such compression rates, such as allowing for High-Definition (2 Megapixel) imagery to be detected using a sensor of about 340×340 (320×240 using 25× compression): No additional hardware is required for disclosed target detection being a processor intensive (software-based) operation.

While various disclosed embodiments have been described above, it should be understood that they have been presented by way of example only, and not as a limitation. Numerous changes to the disclosed embodiments can be made in accordance with the Disclosure herein without departing from the spirit or scope of this Disclosure. Thus, the breadth and scope of this Disclosure should not be limited by any of the above-described embodiments. Rather, the scope of this Disclosure should be defined in accordance with the following claims and their equivalents.

Although disclosed embodiments have been illustrated and described with respect to one or more implementations, equivalent alterations and modifications will occur to others skilled in the art upon the reading and understanding of this specification and the annexed drawings. While a particular feature may have been disclosed with respect to only one of several implementations, such a feature may be combined with one or more other features of the other implementations as may be desired and advantageous for any given or particular application.

The terminology used herein is for the purpose of describing particular embodiments only and is not intended to be limiting to this Disclosure. As used herein, the singular forms “a,” “an,” and “the” are intended to include the plural forms as well, unless the context clearly indicates otherwise. Furthermore, to the extent that the terms “including,” “includes,” “having,” “has,” “with,” or variants thereof are used in either the detailed description and/or the claims, such terms are intended to be inclusive in a manner similar to the term “comprising.”

Unless otherwise defined, all terms (including technical and scientific terms) used herein have the same meaning as commonly understood by one of ordinary skill in the art to which this Disclosure belongs. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

We claim:

1. A method of image exploitation, comprising:
encoding light from a scene of interest by adding projective codes to generate encoded light, wherein said projective codes are expressed as a product of a known projective code matrix with a known reconstruction matrix representing an image reconstruction operation;
detecting said encoded light at a photodetector to generate a plurality (k) of measurements that represent an image;
processing said plurality of measurements by compressive sensing including projective sub-sampling to represent said plurality of measurements as a linear system, wherein said linear system is expressed as a plurality of undetermined linear equations including a product of said known reconstruction matrix and an unknown sparse vector,
approximating said sparse vector to provide solutions to said plurality of undetermined linear equations, and
generating at least one of a reconstructed image and an exploited image from said plurality (k) of measurements using said solutions to said plurality of undetermined linear equations, wherein a product of said known reconstruction matrix with said solutions to said underdetermined linear equations provides an image representation of said scene of interest having N pixels, wherein N>k.

2. The method of claim 1, wherein said known reconstruction matrix comprises an identity matrix and said generating provides said reconstructed image.

3. The method of claim 1, wherein said reconstruction matrix comprises a known exploitation matrix, said projective codes comprise exploitation-projective codes, and said generating provides said exploited image.

4. The method of claim 1, wherein said generating comprises utilizing at least one Quadratic Correlation Filter (QCF).

5. The method of claim 4, further comprising training said QCF from previously acquired scene data to respond to areas in imagery having a target of interest with a relatively high value response and to respond to target-less areas in said imagery with a lower value response.

6. The method of claim 1, wherein a spatial light modulator (SLM) is used for said encoding.

7. A coded aperture imaging system, comprising:
a spatial light modulator (SLM) for adding projective codes to light received from a scene of interest to provide encoded light, wherein said projective codes are expressed as a product of a known projective code matrix with a known reconstruction matrix representing an image reconstruction operation;
a photodetector optically coupled to said SLM for detecting said encoded light to generate a plurality (k) of measurements;
a memory which stores an imaging algorithm having code for implementing image reconstruction for generating a reconstructed image;
a processor coupled to said photodetector to receive said plurality (k) of measurements, and coupled to said memory for programming with said code to implement said imaging algorithm, said imaging algorithm:
processing said plurality (k) of measurements by compressive sensing including projective sub-sampling to represent said plurality (k) of measurements as a linear system,
wherein said linear system is expressed as a plurality of undetermined linear equations including a product of said known reconstruction matrix and an unknown sparse vector,
approximating said sparse vector to provide solutions to said plurality of undetermined linear equations, and
generating said reconstructed image from said plurality (k) of measurements using said solutions to said undetermined linear equations, wherein a product of said known reconstruction matrix with said solutions to said plurality of underdetermined linear equations provides an image representation of said scene of interest having N pixels, wherein N>k.

8. The system of claim 7, wherein said known reconstruction exploitation matrix comprises an identity matrix and said generating provides said reconstructed image.

9. The system of claim 7, wherein said reconstruction matrix comprises a known exploitation matrix, said projective codes comprise exploitation-projective codes, and said generating provides said exploited image

10. The system of claim 9, wherein said exploitation-projective codes comprises linear projections.

11. The system of claim 7, wherein said SLM is a digital micro-mirror array (DMA).

12. The system of claim 7, wherein said generating comprises utilizing at least one Quadratic Correlation Filter (QCF).

13. The system of claim 12, wherein said QCF is trained from previously acquired scene data to respond to areas in imagery having a target of interest with a relatively high value response and to respond to target-less areas in said imagery with a lower value response.

14. Machine readable storage, comprising:
a non-transitory machine readable storage media having code stored therein, said code including executable instructions, which, when executed by a computing device, cause the computing device to implement an image reconstruction algorithm, said code including:
code for encoding light from a scene of interest by adding projective codes to generate encoded light, wherein said projective codes are expressed as a product of a known projective code matrix with a known reconstruction matrix representing an image reconstruction operation;
code for processing a plurality (k) of measurements provided by a photodetector which detects said encoded light by compressive sensing including projective sub-sampling to represent said plurality of measurements as a linear system, wherein said linear system is expressed as a plurality of undetermined linear equations including a product of said known reconstruction matrix and an unknown sparse vector,
code for approximating said sparse vector to provide solutions to said undetermined linear equations, and
code for generating an reconstructed image from said plurality (k) of measurements using said solutions to said plurality of undetermined linear equations, wherein a product of said known reconstruction matrix with said solutions to said plurality of underdetermined linear equations provides an image representation of said scene of interest having with N pixels, wherein N>k.

15. The machine readable storage of claim 14, wherein said known reconstruction matrix comprises an identity matrix and said generating provides said reconstructed image.

16. The machine readable storage of claim 14, wherein said reconstruction matrix comprises a known exploitation matrix, said projective codes comprise exploitation-projective codes, and said generating provides said exploited image.

17. The machine readable storage of claim 16, wherein said exploitation-projective codes comprise linear projections.

18. The machine readable storage of claim 14, said generating comprises utilizing at least one Quadratic Correlation Filter (QCF).

19. The machine readable storage of claim 14, further comprising code for training said QCF from previously acquired scene data to respond to areas in imagery having a target of interest with a relatively high value response and to respond to target-less areas in said imagery with a lower value response.
